(19) United States
(12) Patent Application Publication
(10) Pub. No.: US 2007/0028511 A1
(43) Pub. Date: Feb. 8, 2007

(54) Liquid delivery apparatus

(75) Inventor: Martin Hazenveld, Port Macquarie (AU)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: IBOS PTY LTD

(21) Appl. No.: 11/324,497

(22) Filed: Jan. 3, 2006

Related U.S. Application Data
(63) Continuation of application No. PCT/AU04/00886, filed on Jul. 2, 2004.

(30) Foreign Application Priority Data
Jul. 3, 2003 (AU) 2003903475

(51) Int. Cl. A01M 21/04

(52) U.S. Cl. 47/1.5

(57) ABSTRACT

A liquid delivery apparatus is disclosed which includes a frame supporting a drum. The frame is adapted for displacement relative to a ground surface having plant matter and the drum is rotatably disposed relative to the frame at a rest position having a height above said ground surface which allows for engagement of an outer circumferential surface of the drum with at least some of said plant matter. The apparatus has at least one applicator for application of a liquid onto the circumferential surface such that the liquid is transferable to at least some of the plant matter as the frame is displaced relative to said ground surface. Preferably, the drum is retractably mounted to the frame such that the drum retracts from the rest position upon engagement with a ground obstacle and returns to the rest position subsequent to engagement with the ground obstacle. Another embodiment includes at least one applicator for application of a liquid onto the circumferential surface, the applicator providing a variable liquid application profile along a length of the outer circumferential surface. Yet another embodiment discloses a saturation sensor for determining the degree of saturation of liquid on the circumferential surface of the drum, the saturation sensor providing a measurement of the weight of the drum.

### CROSS-REFERENCE TO RELATED APPLICATIONS

This application is a continuation of International Application No. PCT/AU2004/000886, filed Jul. 2, 2004, which was published in the English language on Jan. 13, 2005, under International Publication No. WO 2005/002739 A1, and the disclosure of which is incorporated herein by reference.

### BACKGROUND OF THE INVENTION

The present invention relates to an improved liquid delivery apparatus of a type known as a rotary wiper. The invention has been developed for use in the application of liquid chemicals, for example weedicide, herbicide and/or fertiliser, to plant matter such as foliage and in particular to weeds. However, it will be appreciated that the invention is not limited to this particular field of use.

Known devices for delivering liquid chemicals to foliage typically include a rotatable drum to which liquid chemicals are applied. The drum is suspended at a height appropriate for the target foliage. The drum is simultaneously displaced and rotated so as to deliver the liquid chemicals onto leaves and other plant matter. Typically, the drum is caused to rotate in a direction opposite to the direction of its displacement. The inventor of the present invention has appreciated a number of disadvantages associated with some of the prior art systems, as outlined below.

Some prior art systems exhibit sub-optimal performance when used on uneven ground. For example, on uneven ground the drum may impact with obstacles such as stumps, rocks, etc. One of the prior art systems mounts the drum onto a three point linkage of a tractor, thereby allowing the tractor driver to remotely adjust height. However in some circumstances, the driver may be unaware of a particular obstacle, for example because it may be hidden in long grass, obscured from view from the tractor driving vantage point or because the tractor driver is momentarily distracted. In such cases the drum or other associated equipment may be damaged by the resultant impact.

Another prior art arrangement includes a wheeled frame which may be towed behind a vehicle such as a tractor, four wheeled all terrain vehicle, four wheel bike, etc. This prior art arrangement allows for manual adjustment of the height at which the drum is suspended relative to the ground. Once again, the operator must be alert to potential impacts of the drum with obstacles and may have to stop to manually adjust the drum height to provide sufficient clearance for the drum to pass over particular obstacles. This process may be inefficient and laborious in some circumstances.

Both of the above mentioned prior art arrangements require the operator to limit the speed of displacement of the drum over the foliage to allow time for identification of obstacles and to limit the damage when impacts inadvertently occur. This increases the time required to complete the liquid delivery process over a given area, which is a particular problem given that to achieve optimum results the operation must be completed within a limited window of opportunity due to various seasonal, weather and biological factors. Operating outside this window may cause the plant material to develop resistance to the liquid chemical. This has been identified as a major problem in farming.

Some prior art systems require the operator to manually adjust the rate at which liquid chemical is applied to the drum. This also requires a considerable degree of concentration by the user to ensure that sufficient chemical is applied to the roller to ensure adequate delivery onto the target foliage. However, the application of excess liquid onto the drum will often result in wastage and damage to non-target plants, particularly if the drum is over saturated and the chemical begins to drip off the drum.

If operated on sloping surfaces, it is possible for the liquid chemical in some prior art systems to flow longitudinally across the drum, possibly resulting in over saturation of one end of the drum and insufficient supply of liquid on the opposite end of the drum.

### BRIEF SUMMARY OF THE INVENTION

It is an object of the present invention to overcome or ameliorate at least some of the disadvantages of the prior art, or at the very least to provide a useful alternative.

According to a first aspect of the invention there is provided a liquid delivery apparatus including:
a frame adapted for displacement relative to a ground surface having plant matter;
a drum rotatably disposed relative to said frame at a rest position having a height above said ground surface allowing for engagement of an outer circumferential surface of the drum with at least some of said plant matter; and
at least one applicator for application of a liquid onto said circumferential surface such that said liquid is transferable to said at least some of said plant matter as the frame is displaced relative to said ground surface; whereby
said drum is retractably mounted to said frame such that said drum retracts from said rest position upon engagement with a ground obstacle and returns to said rest position subsequent to engagement with said ground obstacle.

Preferably, the drum is retractably mounted to the frame by means of at least one swing arm. More preferably, the swing arm is mounted to the frame for angular movement about a rotational axis which is transverse to a direction of displacement of the frame relative to the ground surface.

In one preferred embodiment, the rest position is defined by engagement of the swing arm with a stop. With preference, the swing arm is biased toward the rest position. More preferably, the biasing is achieved by means of gravitational biasing and/or resilient biasing.

In another preferred embodiment, a proximate end of the swing arm is mounted to the frame and the drum is disposed at a distal end of the swing arm. Preferably the distal end trails the proximate end with reference to a direction of displacement of the frame relative to said ground surface.

Preferably, the applicator is disposed on the swing arm intermediate the proximate and distal ends.

A preferred embodiment of the invention includes spraying equipment, for example a boom, disposed on the frame so as to spray liquid onto plant matter. This preferably enhances the chemical effectiveness of the liquid due to dispersion of the liquid over a larger plant matter surface area and/or it allows liquid to be transferred down to root of plant material.

According to a second aspect of the invention there is provided a liquid delivery apparatus including:
a frame adapted for displacement relative to a ground surface having plant matter;
a drum rotatably disposed relative to said frame at a rest position defining a height above said ground surface allowing for engagement of an outer circumferential surface of the drum with at least some of said plant matter; and
at least one applicator for application of a liquid onto said circumferential surface such that said liquid is transferable to said at least some of said plant matter as the frame is displaced relative to said ground surface, said applicator providing a variable liquid application profile along a length of said outer circumferential surface.

Preferably said drum is retractably mounted to said frame such that said drum retracts from said rest position upon engagement with a ground obstacle and returns to said rest position subsequent to engagement with said ground obstacle.

Preferably, the drum defines a first end and a second end opposite said first end. More preferably the length of the outer circumferential surface along which the liquid application profile is variable extends between the first and second ends.

In one preferred embodiment, the variable liquid application profile is selectively adjustable so as to bias liquid application in favour of either the first end or the second end. Preferably, the variable liquid application profile varies substantially linearly between a minimum at one of the first or second ends and a maximum at the other of the first or second ends.

A preferred embodiment of an applicator includes at least a first liquid delivery circuit being biased toward delivery of liquid in favour of the first end and a second liquid delivery circuit being biased toward delivery of liquid in favour of the second end. Said preferred embodiment also includes a first valve for regulation of a flow of liquid to the first liquid delivery circuit and a second valve for regulation of a flow of liquid to the second liquid delivery circuit. In one preferred embodiment, the first valve and the second valve are independently adjustable by a user.

Another preferred embodiment includes a tilt sensor for sensing of a tilt of said first end relative to said second end. In this preferred embodiment, a balance of liquid flows to the first liquid delivery circuit and/or the second liquid delivery circuit is regulated by the tilt sensor so as to maintain a substantially constant degree of liquid saturation across said circumferential surface. In yet another preferred embodiment the tilt sensor and a liquid flow control valve are incorporated in one unit.

According to a third aspect of the invention there is provided a liquid delivery apparatus including:
a frame adapted for displacement relative to a ground surface having plant matter;
a drum rotatably disposed relative to said frame at a rest position defining a height above said ground surface allowing for engagement of an outer circumferential surface of the drum with at least some of said plant matter;
at least one applicator for application of a liquid onto said circumferential surface such that said liquid is transferable to said at least some of said plant matter as the frame is displaced relative to said ground surface; and
a saturation sensor for determining the degree of saturation of liquid on said circumferential surface, a flow of liquid to said applicator being regulated by said sensor.

Preferably, the saturation sensor provides a measurement of the weight of the drum.

Again, preferably, the drum is retractably mounted to the frame by means of at least one swing arm. More preferably, the swing arm is mounted to the frame for angular movement about a rotational axis which is transverse to a direction of displacement of the frame relative to the ground surface.

In one of the preferred embodiments, the drum defines a first end and a second end opposite the first end and the saturation sensor includes a first weight sensing unit disposed adjacent the first end and a second weight sensing unit disposed adjacent the second end.

According to another aspect of the invention, there is provided first and second liquid delivery apparatuses adapted for side-by-side deployment including:
a hitching point common to both said first and second liquid delivery apparatuses;
said first liquid delivery apparatus including:
a first frame having ground engagement means engaging the ground at a distance L₂ from said common hitching point; and
a first drum rotatably disposed relative to said first frame at a rest position defining a distance L₁ from said common hitching point;
said second liquid delivery apparatus including:
a second frame having ground engagement means engaging the ground at a distance L₄ from said common hitching point; and
a second drum rotatably disposed relative to said second frame at a rest position defining a distance L₃ from said common hitching point;
wherein a first ratio L₁:L₂ is substantially equal to a second ratio L₃:L₄ such that an adjustment to the height of the common hitching point results in an alteration to the height of said first drum which is substantially equal to an alteration to the height of said second drum.

Preferably, each drum of the respective apparatuses are each retractably mounted to their respective frames by means of at least one swing arm. More preferably, the swing arm is mounted to the frame for angular movement about a rotational axis which is transverse to a direction of displacement of the frame relative to the ground surface.

When a preferred embodiment of said first and second liquid delivery apparatuses are deployed in side-by-side formation, a liquid distribution coverage area provided by the first drum preferably overlaps with a liquid distribution coverage area provided by the second drum.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic plan view of a first preferred embodiment of a liquid delivery apparatus according to the present invention;

FIG. 2 is a schematic side view of the liquid delivery apparatus shown in FIG. 1;

FIG. 3 is a schematic rear view of the liquid delivery apparatus shown in FIG. 1;

FIG. 4 is a schematic side view of an alternative embodiment of a liquid delivery apparatus according to the present invention;

FIG. 5 is a schematic side view of another alternative embodiment of a liquid delivery apparatus according to the present invention;

FIG. 6 is a schematic side view of yet another alternative embodiment of a liquid delivery apparatus according to the present invention;

FIG. 7 is a schematic side view of the liquid delivery apparatus shown in FIG. 6;

FIG. 8 is a schematic side view of yet another alternative embodiment of a liquid delivery apparatus according to the present invention;

FIG. 9 is a rear view of yet another alternative embodiment of a liquid delivery apparatus according to the present invention;

FIGS. 10 to 13 are schematic side views of liquid applicators according to preferred embodiments of the present invention;

FIG. 14 is a schematic side view of an alternative drum mounting arrangement according to a preferred embodiment of the present invention;

FIG. 15 is a schematic side view of two liquid delivery apparatuses being towed in side-by-side formation;

FIG. 16 is a schematic partial side view of the two liquid delivery apparatuses shown in FIG. 15;

FIG. 17 is a schematic side view depiction of the effect on drum heights on the two liquid delivery apparatuses shown in FIG. 15 when the hitching point is raised or lowered;

FIG. 18 is a schematic partial plan view of the two liquid delivery apparatuses shown in FIG. 15;

FIG. 19 is another schematic side view of two liquid delivery apparatuses being towed in side-by-side formation;

FIG. 20 is a schematic plan view of four liquid delivery apparatuses being towed in side-by-side formation; and

FIGS. 21 to 27 are depictions of preferred liquid application profiles.

### DETAILED DESCRIPTION OF THE INVENTION

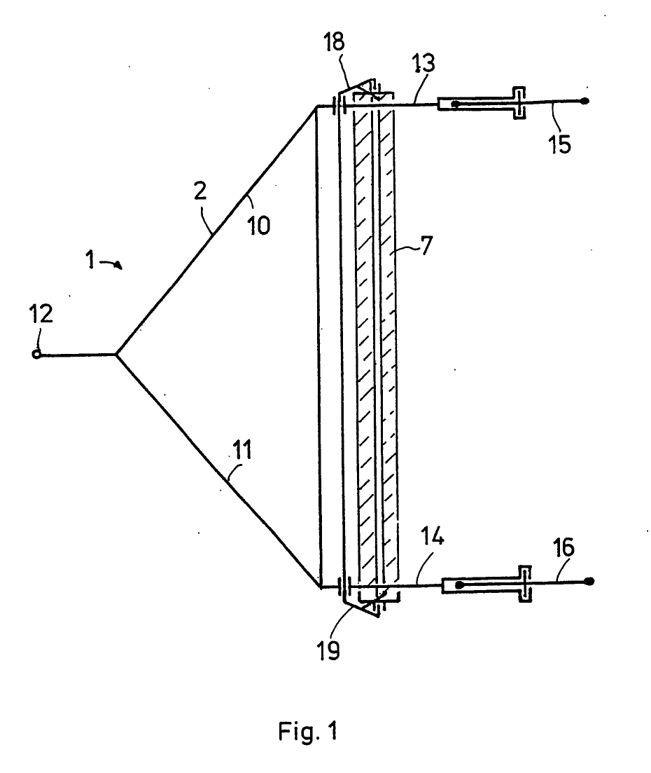

Referring to the drawings, and in particular firstly to FIGS. 1 to 3, a first embodiment of a liquid delivery apparatus 1 includes a frame 2 adapted for displacement relative to a ground surface 3 having plant matter 4, 5 and 6. The frame 2 is adapted for attachment at hitching point 12 to a vehicle, for example a tractor, a four wheeled bike, a four wheel drive, etc. A pair of members 10 and 11 diverge from the hitching point 12 to rearwardly extending members 13 and 14 to which a pair of wheels 15 and 16 are respectively rotatably disposed.

The illustrated embodiments are adapted to be towed behind a vehicle. However other embodiments are adapted for mounting to the front or the side of a vehicle such as a tractor or the like. This allows application of liquid to plant matter 4 and 5 prior to any flattening of the plant matter 4 and 5 that may be caused by the wheels of the vehicle.

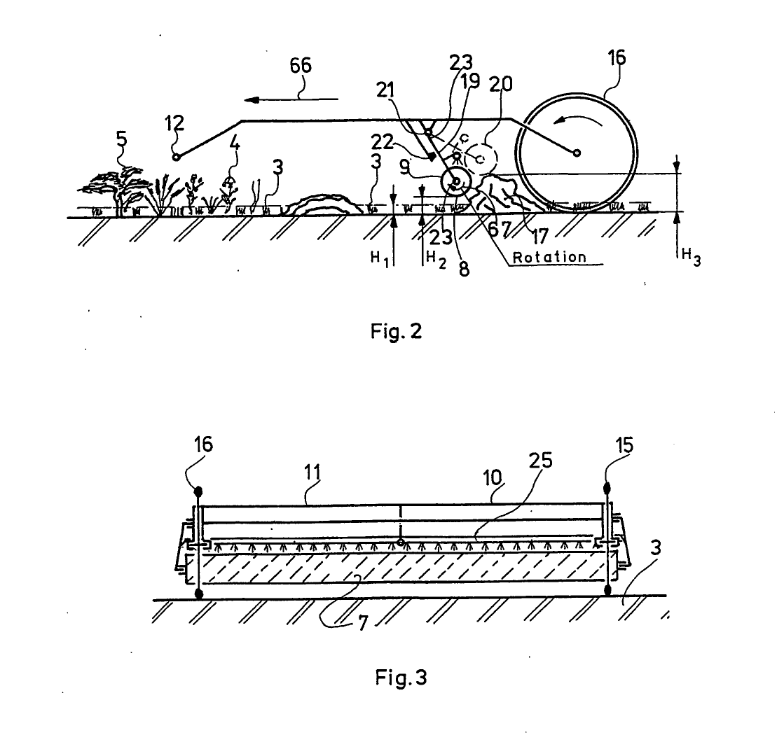

As best shown in FIG. 2, the invention is best suited for applications in which unwanted target foliage, for example weeds 4 and 5, outgrow desired foliage such as crops 6. Hence the height differential between the unwanted target foliage 4 and 5 and the desired foliage 6 allows the selective delivery of one or more liquid chemicals, for example herbicide to the unwanted foliage 4 and 5. However the invention is also suited to other applications, for example those in which it is desired to apply liquids that may enhance plant growth, such as fertilisers and the like.

A drum 7 is rotatably disposed relative to the frame 2 at a rest position 8. This positions an outer circumferential surface 9 of the drum 7 at a height H₂ above the ground surface 3. H₂ is selected to be slightly greater than an average height H₁ of the desired foliage 6. This allows for engagement of the outer circumferential surface 9 of the drum 7 with the unwanted target foliage 4, 5. The circumferential surface 9 of the drum 7 has a capacity to store a volume of liquid. In one preferred embodiment a fabric material, such as an absorbent material, provides the circumferential surface.

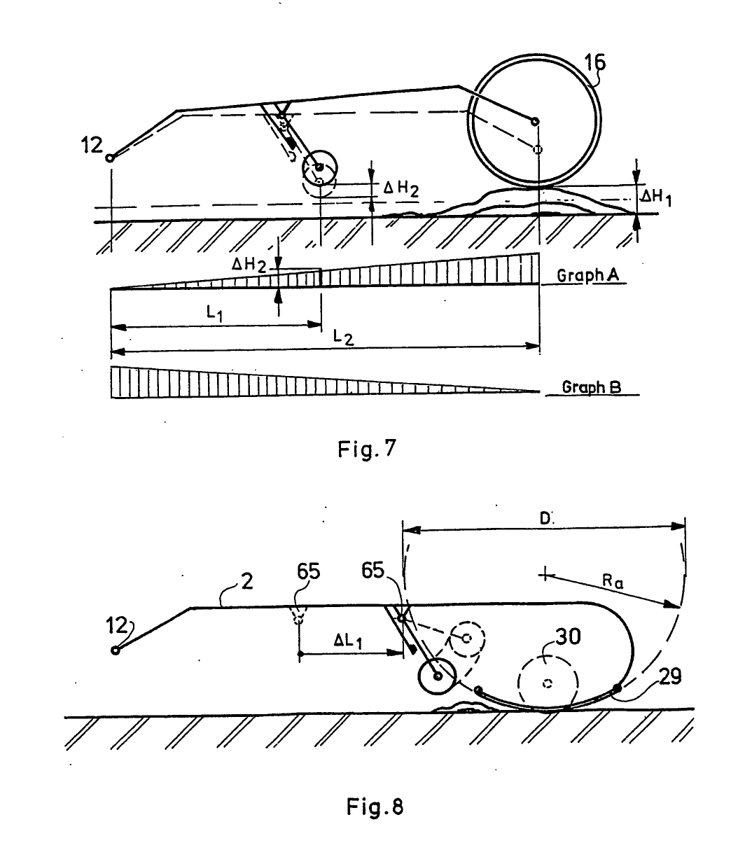

As shown in FIG. 6, the operational height H₂ of the drum 7 can be adjusted by raising or lowering the hitching point 12, for example by means of raising or lowering a three point linkage as is commonly available on a tractor. The height adjustment of the drum 7 (i.e. from H₂ to H₆) resulting from a height adjustment of the hitching point 12 (i.e. from H₄ to H₅) is adjustable by altering the ratio L₁:L₂ (where L₁ is the length between the hitching point 12 and the drum 7 and L₂ is the length between the hitching point 12 and the wheel 15). A lower L₁:L₂ ratio causes the height of the drum 7 to be more affected by an alteration of the hitching height and vice versa. As the vehicle towing the liquid dispensing apparatus 1 moves over uneven ground 3, it may be displaced vertically, resulting in vertical displacement of the hitching point 12, which, in turn, causes vertical displacement of the drum 7 as shown in graph B of FIG. 7.

Similarly, as shown in graph A FIG. 7, the degree to which the operative height H₂ of the drum 7 is affected by displacement of the wheel 15 over an obstacle 17 is also dependent upon the L₁:L₂ ratio. A lower L₁:L₂ ratio results in a lesser alteration of the operative height of the drum 7 in response to a given elevation of the wheel due to an obstacle, and vice versa.

Taking into account the effects shown in graphs A and B of FIG. 7, for some preferred embodiments, the optimum distance L₁ will be about halfway along L₂, or biased towards the rear wheels 16 or skids 29 (as illustrated in following embodiments). This will allow the operator to displace the frame 2 across uneven ground at higher speeds. For applications where the ground surface 3 is curved up/down and the operator does not have remote adjustability of the height of the hitching point, it is generally preferable for the drum 7 to be positioned close to the wheels 16 (or close to the skid 29 as the case may be) so as to minimise the disturbance to the operative height of the drum 7.

Some embodiments of the invention allow for adjustment of the operative height of the drum 7 without recourse to adjustment of the height of the hitching point. Such embodiments are particularly suited for towing behind vehicles which do not feature remote adjustment of the height of the hitching point, for example four wheeled bikes, cars and the like. In some embodiments the operative height of the drum 7 is adjustable by any one or more of the following means:
adjusting the height of the pivot point 65,
adjusting the length of the swing arm 18;
adjusting the height of the wheels 16 or the skids 29; and/or
adjusting the position along the swing arm 18 at which the drum 7 is disposed.

It will be appreciated by those skilled in the art that other means for adjusting the operative height of the drum 7 are also available.

It will also be appreciated that various embodiments may include locking means to engage the drum in the retracted or other locked position, for example when transporting the apparatus.

As shown in FIG. 8, some preferred embodiments of the invention provide a detachable swing arm pivot point 65. This allows the swing arm pivot point 65, and therefore the swing arm 18 and attached drum 7, to be shifted if the operator desires to alter the L₁:L₂ ratio. In this case the swing arm pivot point 65 is simply detached from the frame 2, shifted either forwards or rearwards, then re-attached to the frame 2 to yield the desired L₁:L₂ ratio.

Another variation provided by an alternative preferred embodiment which allows for higher speeds across uneven ground is shown in FIG. 8. A pair of skids 29 takes the place of the wheels 15 and 16. The skids 29 have a radius of curvature Ra which is greater than that of the standard wheels 15 and 16. The greater radius allows the skid 29 to ride the bumps of the uneven ground 3 more smoothly. The fact that the skid 29 does not form a full circle having a radius Ra helps to provide sufficient clearance for the swing arm 18 to be mounted to the frame 2 in a preferred position. A smaller wheel 30 may be disposed at the base of the skid 29 to allow the frame 2 to be displaced without dragging the skid 29, for example when towing the liquid delivery apparatus 1 across paved surfaces, or over other surfaces when it is not being utilised. The wheel 30 also assists to minimise damage to the vegetation 4, 5 and 6 by the skids 29.

The liquid chemical is stored in a reservoir and is pumped to an applicator 25 which applies the liquid along the length of the circumferential surface 9. The liquid is then transferable to the target plant matter 5 as the frame 2 is displaced relative to the ground surface 3.

The drum 7 is retractably mounted to the frame 2 to allow the drum 7 to retract from the rest position 8 upon engagement with a ground obstacle 17 having a height H₃ greater than H₂. This assists to minimise the risk of damage to the drum 7 and associated machinery. A dotted outline of the drum 7 is depicted in a retracted position in FIG. 2. Subsequent to engagement with the ground obstacle 17, the drum 7 returns to the rest position 8.

The drum 7 is retractably mounted to the frame 2 by means of two swing arms 18 and 19 which are mounted to the frame 2 for angular movement about a rotational axis 21. In some embodiments a torsional unit with additional levers as required, may be utilised to provide the connection between the swing arms and frame. The inclusion of the torsional device plus lever(s) assists the backward movement of the drum upon impact. However, with advantage, it is been found useful to provide the linkage between the swing arms and the frame in the form of short chain members, thereby allowing a greater degree of independent movement of each swing arm relative to the frame.

In some embodiments the two swing arms 18 and 19 are joined by a third member which extends along the rotational axis 21, thereby forming a unitary U-shaped swing arm member. The rotational axis 21 is transverse to an intended direction of displacement 66 of the frame 2 relative to the ground surface 3. The rest position 8 is defined by engagement of the swing arm 18 and/or 19 with a stop 22.

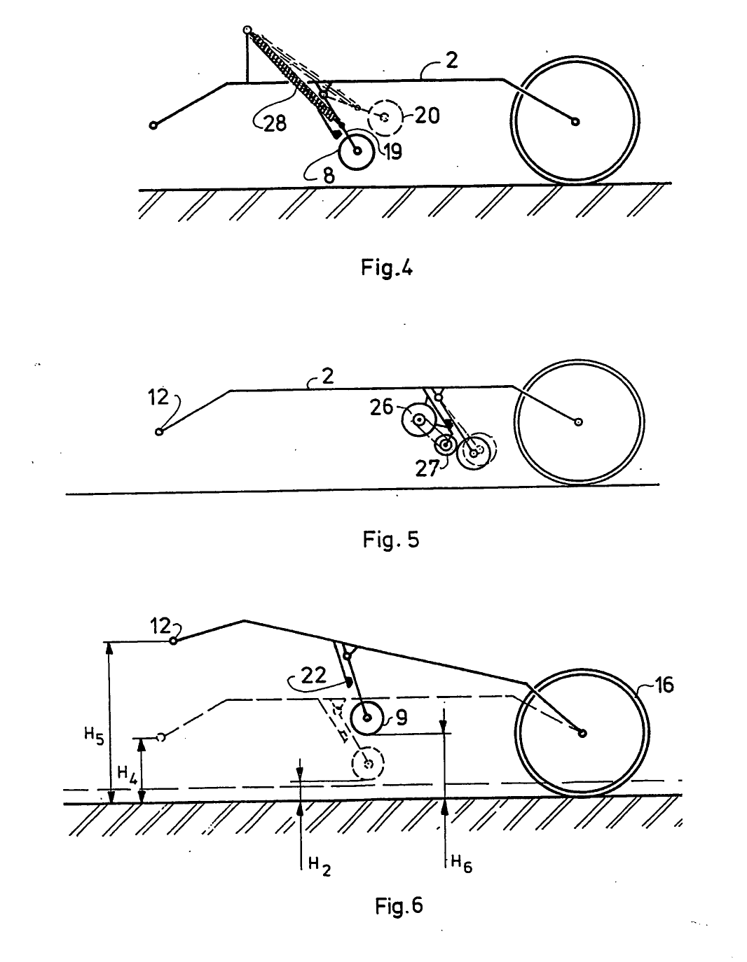

The swing arms 18 and 19 are biased towards returning the drum 7 to the rest position 8. In the embodiment illustrated in FIG. 2 this biasing is gravitational biasing. In another embodiment illustrated in FIG. 4 the biasing is a combination of gravitational and resilient biasing. The resilient biasing is provided by a spring 28 which is disposed so as to bias the swing arm 19 toward the rest position 8 when the drum 7 is at the rest position 8. However, once the drum 7 has been displaced sufficiently away from the rest position, the spring 28 goes over-centre to exert a force which assists to lift the drum 7 away from the rest position 8 and over obstacle 17. In this way engagement between the drum 7 and the obstacle 17 is minimised, thereby minimising the potential for damage to the drum 7.

The spring constant of the spring 28 is selected to ensure that gravitational biasing overcomes the lifting action such that the drum 7 returns to the rest position 8 once the obstacle 17 has been cleared.

In case that more than sufficient biasing towards the stop position is the case, the over-centre action can be reduced or eliminated so that only an uplift force is exerted.

Another embodiment of the invention includes a movement sensor for detection of initial movement of the swing arm 19 in response to engagement of the drum 7 with an obstacle 17. Once this is sensed, an actuator, for example a hydraulic or electric actuator, is employed to force the drum 7 upwardly and away from the obstacle 17. In this way, the drum 7 is only fleetingly subject to the risk of damage from the obstacle 17 before it is actively retracted away from the rest position 8.

In yet another embodiment a proximity sensor is employed to detect the proximity of an obstacle 17 to the drum 7. In a similar manner, an actuator is then employed to actively retract the drum 7 away from the rest position 8. Hence, the drum 7 is safely retracted immediately prior to impact of the drum 7 against the obstacle 17. Once the proximity sensor confirms that the obstacle 17 has passed safely under the drum 7, the actuator is employed to lower the drum 7 back to the rest position 8.

A proximate end 23 of the swing arm 19 is mounted to the frame 2 and the drum 7 is disposed at a distal end 24 of the swing arm 19. The distal end 24 trails the proximate end 23 with reference to the intended direction of displacement 66 of the frame 2 relative to the ground surface 3. In this way, the swing arm 19 allows the drum 7 to retract rearwardly and upwardly away from an obstacle 17.

The liquid applicator 25 is disposed on the swing arms 18 and 19 intermediate the proximate ends 23 and the distal ends 24. Hence, the applicator 25 moves with the drum 7 when it retracts from the rest position 8.

Some embodiments of the invention also include auxiliary liquid applicators disposed on the frame 2 so as to spray liquid directly onto plant matter. This may improve the effectiveness of the applied chemical, after contact with the drum surface 9, due to an increased surface area of application onto the plant matter 4 and 5. At higher rates of liquid delivery via the auxiliary applicator, this embodiment is particularly suited for use with liquid chemicals which are designed for uptake via the root system of the plant matter.

The embodiment illustrated in FIG. 5 further includes drive means 26 for rotating the drum 7. In some preferred embodiments the direction of rotation of the drum 7 is counter to the intended direction of displacement of the frame 2 relative to the ground surface 3. In other words, the lowermost circumferential surface 9 of the drum 7 is rotated in a direction from the back of the frame 2 toward the front of the frame 2. This helps the drum 7 to deliver the liquid to the underside of the target foliage, which helps to ensure that the liquid is protected from rainfall and direct sunlight for improved chemical action once it has been delivered onto the plant matter 4 and 5. In yet other embodiments, the drum 7 is driven to rotate in the same direction as the intended direction of displacement of the frame 2 relative to the ground surface 3.

The drum 7 is rotated by the drive means 26 whilst the drum 7 is in the rest position 8. When the drum 7 is retracted from the rest position 8 it is allowed to freewheel. This assists the drum 7 to ride over obstacles 17 and also assists to avoid tearing of the fabric on the circumferential surface 9 of the drum 7. The drive means is in the form of an electric or hydraulic motor 26 which drives a friction wheel 27, which, in turn, rotationally engages the circumferential surface of the drum 7 whilst it is in the rest position 8. On the other hand, the circumferential surface 9 is spaced from the friction wheel 27 when the drum 7 is retracted from the rest position 8, thereby allowing the drum to freewheel. In other embodiments the drive means 26 is provided by a mechanical connection to the ground engaging wheels 16.

In use the liquid delivery apparatus 1 is displaced in a direction shown by arrow 66 in FIG. 2. Whilst in the rest position 8, the drum is driven to counter-rotate in the direction given by arrow 67. As the liquid delivery apparatus 1 moves over the plant matter 4, the liquid is transferred from the drum 7 and onto at least some of the plant matter 4. The counter-rotation of the drum 7 helps to spread the liquid over a large surface area of the target plant matter 4 which assists the chemical action of many liquids commonly used in farming, such as herbicides, etc. If the drum 7 strikes an obstacle 17, the drum retracts from the rest position 8 and freewheels until it clears the obstacle 17, at which point it returns to the rest position 8 and starts rotating again. Another embodiment reduces the risk of damage to the drum 7 and the drum surface 9 by detecting an initial upswing from the rest position 8 and stopping or disengaging the drive means 26 with a clutch.

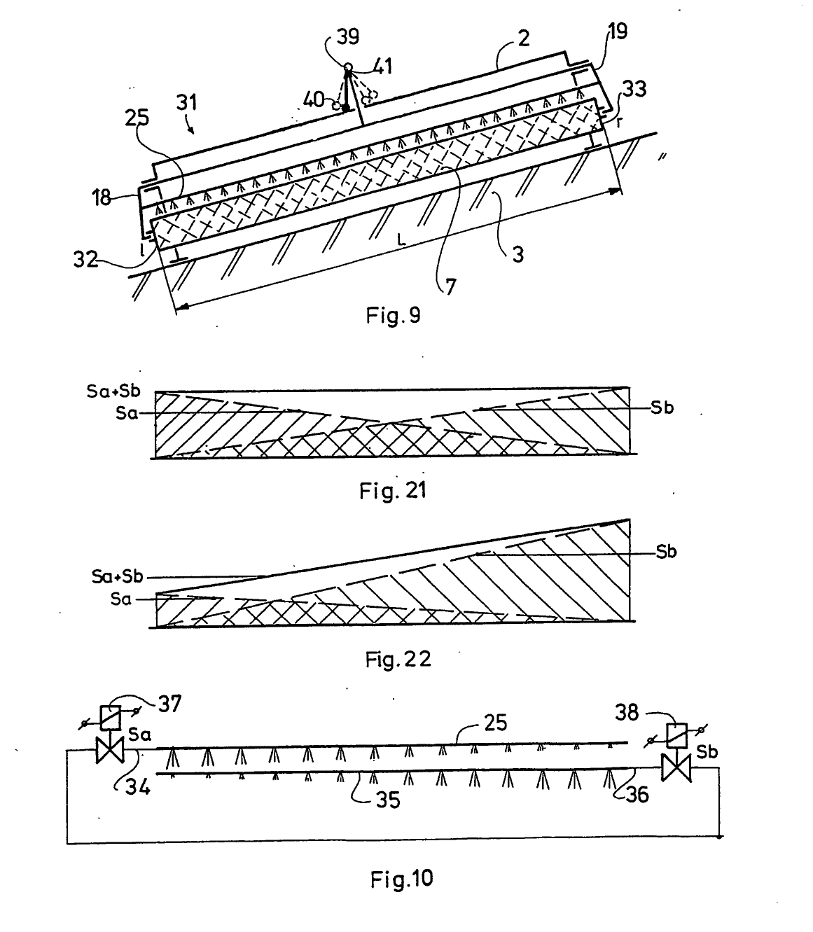

FIGS. 9 to 13 and 21 to 27 illustrate a liquid delivery apparatus 31 which is adapted for use across sloping surfaces. Some of the features of this embodiment which are similar or identical to those mentioned above are labelled with the same reference numerals, for example the frame 2 and the drum 7.

One of the preferred embodiments makes use of two applicators 25 to apply liquid onto a length of the circumferential surface 7. The applicators 25 combine to provide variable liquid application profiles, such as those shown in FIGS. 21 to 27, to the outer circumferential surface 9 of the drum 7. The illustrated applicators 25 include nozzles 42 which release jets of liquid onto the circumferential surface 9. Other embodiments have applicators 25 in the form of drippers or the like.

The drum 7 defines a first end 32 and a second end 33 opposite the first end 32. Some preferred embodiments provide a liquid application profile which varies between the first and second ends 32 and 33. When used across sloping ground 3, one of the first or second ends 32 or 33 may be higher than the other and liquid applied to the drum 7 will therefore have a tendency to flow towards the lower end, possibly causing over saturation of the lower end and excessive dryness of the opposite end. Hence, a variable liquid application profile may be used to partially or completely compensate for the otherwise uneven saturation of the drum 7 on a sloping surface 3. More particularly, the variable liquid application profile is selectively adjustable so as to bias liquid application in favour of either the first end 32 or the second end 33, as needed. In some embodiments the variable liquid application profile varies substantially linearly between a minimum at one of the first or second ends 32 or 33 and a maximum at the other of the first or second ends 32 or 33.

A first applicator 25 forms part of a first liquid delivery circuit 34 as shown in FIG. 10 which is biased toward delivery of liquid in favour of the first end 32. The water delivery profile provided by this circuit 34 is shown as Sa in FIGS. 21 and 22. A first valve 37 regulates a flow of liquid to the first liquid delivery circuit 34.

A second applicator 35 forms part of a second liquid delivery circuit 36, as shown in FIG. 10, which is biased toward delivery of liquid in favour of the second end 33. The water delivery profile provided by this circuit 36 is shown as Sb in FIGS. 21 and 22. A second valve 38 regulates a flow of liquid to the second liquid delivery circuit 36.

In the preferred embodiment illustrated in FIGS. 9, 10, 21 and 22, the two circuits 34 and 36 function in parallel, with each of the applicators 25 and 35 supplying a total amount of liquid varying from zero to a maximum dependent upon the supply regulated by their respective valves 37 and 38.

If both valves 37 and 38 are opened equally, the output of the first liquid delivery circuit 34, Sa, is combined with the output of the second liquid delivery circuit 36, Sb, to produce composite output Sa+Sb, which is a substantially constant liquid delivery profile along the length of the drum 7, as shown in FIG. 21. This composite output is suited to use on ground that does not slope. Alternatively, if one of the valves (say, Sa) is partially closed relative to the other valve (Sb) then a resultant composite output Sa+Sb as illustrated in FIG. 22 is provided. This composite output is suited to sloping ground for which a minimal, but non-zero, liquid supply is required for the first end 32 and an increased liquid supply is required for the second end 33.

In some embodiments the first valve 37 and the second valve 38 are independently adjustable by a user, for example, by means of one or more remotely adjustable knobs. Yet other embodiments make use of a tilt sensor 39 for sensing of a tilt of the first end 32 relative to the second end 33. In such embodiments, a balance of liquid flows to the first liquid delivery circuit 34 and to the second liquid delivery circuit 36 is regulated by the tilt sensor 39 so as to maintain a substantially constant degree of liquid saturation across the circumferential surface 9 of the drum 7. One example of such a tilt sensor 39 is a plumb bob 40 suspended as a pendulum from a potentiometer 41. Hence, a particular angle of slope of the first end 32 relative to the second end 33 corresponds to a particular voltage output from the potentiometer, which, in turn, causes electronic solenoids to adjust the valves 37 and 38 to yield a predetermined balance of liquid flows to the first and/or second liquid delivery circuits 34 and 36.

In some preferred embodiments, the tilt sensor is part of a single unit which also incorporates control valves to regulate the flow of liquid to the first and second delivery circuits 34 and 36.

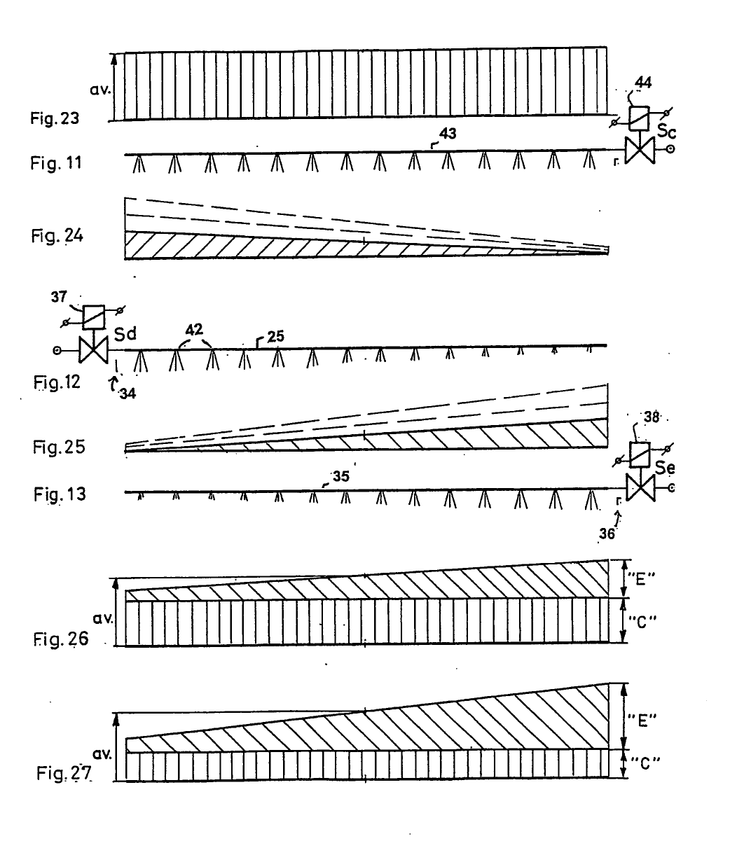

Further variations of liquid distribution profiles are obtainable with the inclusion of a third applicator 43 as shown in FIG. 11. This applicator 43 is not biased in favour of the first or second end 32 or 33. Rather, it provides a constant liquid output along the length of the drum 7, as illustrated by the flat liquid distribution profile shown in FIG. 23. The flow of liquid to the third applicator 43 is regulated by a third valve 44. This arrangement allows for the output of liquid distribution profiles such as those shown in FIGS. 26 and 27.

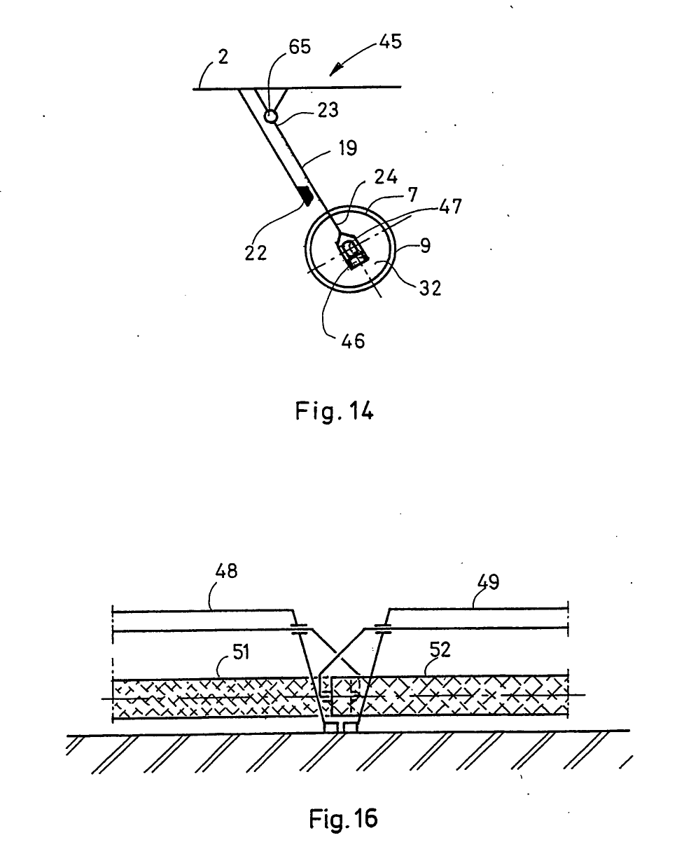

The flow of liquid to the third applicator 43 in some embodiments is manually regulated and in other embodiments is regulated by a timer so as to adjust for differing levels of liquid uptake by the plant matter 4 and 5. As illustrated in FIG. 14, yet another embodiment of a liquid delivery apparatus 45 includes a saturation sensor 46 for determining the degree of saturation of liquid on the circumferential surface 9 of the drum 7. This allows a flow of liquid to one or more of the applicators 25, 35 or 43 to be regulated by the saturation sensor 46 to automatically maintain saturation of the circumferential surface to within predefined limits. One method of sensing the saturation of a drum 7 is to measure its weight since a fully saturated drum 7 weighs significantly more than a dry drum 7, with the degree of saturation being roughly linear between these two extremes. The degree of saturation of a drum 7 may be readily calculated via knowledge of the following figures:
the dry weight (W_{d}) of the drum;
the fully saturated weight (Wₛ) of the drum and
the measured weight (Wₘ) of the drum at a particular point in time.

In such a case, a measure of the saturation ratio (S) of the drum at that point in time is given by:

$$S = \frac{{W}_{m} - {W}_{d}}{{W}_{s} - {W}_{d}}$$

For example, for certain applications a user may decide to maintain the circumferential surface 9 of the drum 7 at a saturation ratio (S) of between 0.5 and 0.75 (i.e. between a half and three quarters of the fully saturated state). This range may ensure that the drum 7 is sufficiently saturated to deliver sufficient quantities of liquid to the target plant matter 4, but not so saturated as to promote wastage of the liquid. In such a case, if the saturation ratio falls below 0.5 the flow of liquid to the applicators 25, 35 and/or 43 is increased via appropriate manipulation of one or more of valves 37, 38 or 44. On the other hand, if the saturation ratio exceeds 0.75, the flow is decreased or temporarily halted.

In the embodiment illustrated in FIG. 14 the drum 7 defines a first end 32 and a second opposite end 33. The saturation sensor 46 includes a first weight sensing unit disposed adjacent the first end and a second weight sensing unit disposed adjacent the second end. Each of the weight sensing units 46 support the axel 47 about which the drum 7 rotates. Each of the weight sending units 46 provide a voltage output which is proportional to the measured weight at the end 32 or 33 of the drum at which the relevant weight sensing unit is disposed. The two outputs of the two weight sending units 46 may be summed to give a voltage which is proportional to Wₘ. In this embodiment the pair of weight sensing units 46 may function as not only saturation sensors, but also as tilt sensors by analysing any weight differential that may exist between the measurements made by the two weight sensing units 46.

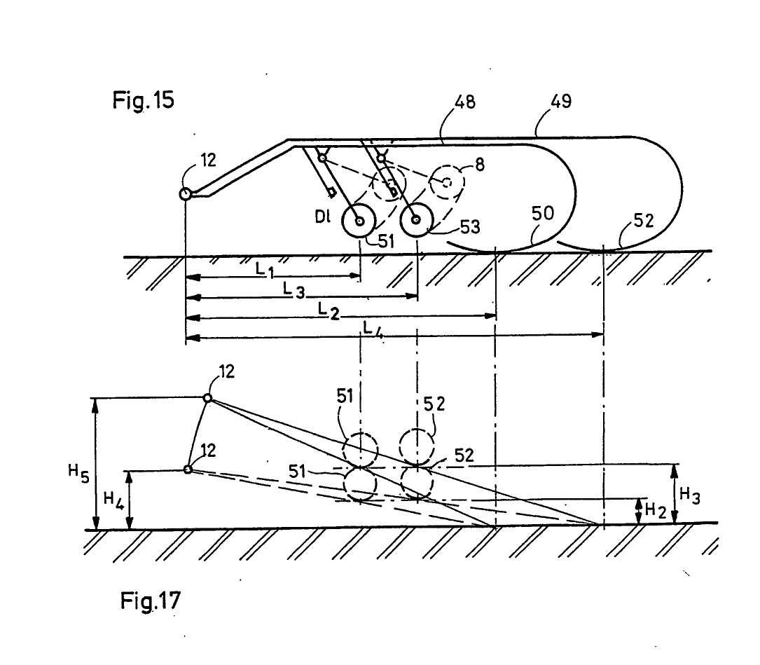

To further increase coverage and thereby the efficiency of the liquid delivery process, the user may utilise alternative embodiments of the invention which allow two liquid delivery apparatuses to operate in side-by-side formation. Such embodiments utilise a hitching point 12 common to both the first and second liquid delivery apparatuses 48 and 49. As best shown in FIG. 15, the first liquid delivery apparatus 48 has a first frame having ground engagement means 50 engaging the ground at a distance L₂ from the common hitching point 12. It also has a first drum 51 rotatably disposed relative to the first frame at a rest position defining a distance L₁ from the common hitching point 12. The second liquid delivery apparatus includes a second frame having ground engagement means 52 engaging the ground at a distance L₄ from the common hitching point 12. It also has a second drum 53 rotatably disposed relative to the second frame at a rest position defining a distance L₃ from the common hitching point 12.

A first ratio of lengths L₁:L₂ is substantially equal to a second ratio of lengths L₃:L₄. This ensures that an adjustment to a height of the common hitching point 12 (from H₄ to H₅ as shown in FIG. 17) results in an alteration to a height of the first drum 51 which is substantially equal to an alteration to a height of the second drum 53 (i.e. the heights of both the first and second drums 51 and 53 increase from H₂ to H₃). This allows the operator the freedom to adjust the height of a single common hitching point 12 and to thereby obtain a uniform adjustment to the operative heights of the two drums 51 and 53.

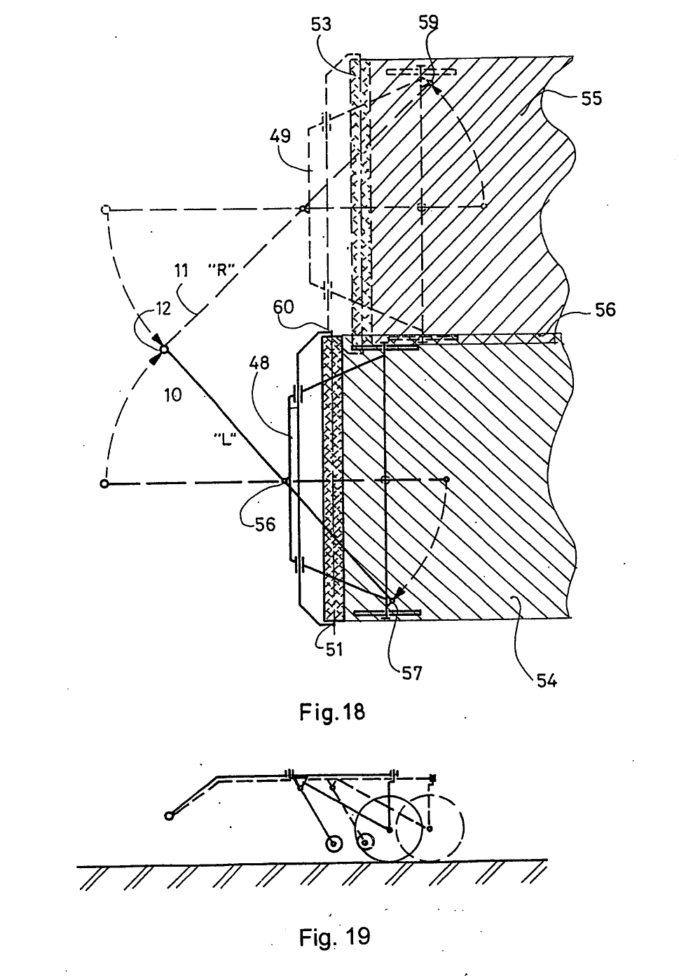

As best shown in FIG. 18, the liquid distribution coverage area 54 provided by the first drum 51 overlaps 56 with the liquid distribution coverage area 55 provided by the second drum 53 when the first and second liquid delivery apparatuses 48 and 49 are deployed in side-by-side formation. FIG. 18 also depicts the adjustment in configuration required for the diverging members 10 and 11 when two liquid delivery apparatuses 48 and 49 are towed in side-by-side formation. Member 10 extends from the common hitching point 12 to the middle 56 of the first liquid delivery apparatus 48 and terminates adjacent the left hand rear corner 57. Similarly, member 11 extends from the common hitching point 12 to the middle 58 of the second liquid delivery apparatus 49 and terminates adjacent the right hand rear corner 59. Additionally, the two liquid delivery apparatuses 48 and 49 engage each other close to the ground and near the wheels 16 or skids 29. This geometry ensures that the two liquid delivery apparatuses 48 and 49 may be towed behind a common hitching point 12 in the desired side-by-side formation. In yet other embodiments the two liquid delivery apparatuses 48 and 49 do not engage each other, but rather trail independently behind the common hitching point 12, with alignment being maintained by the wheels 16 or skids 29.

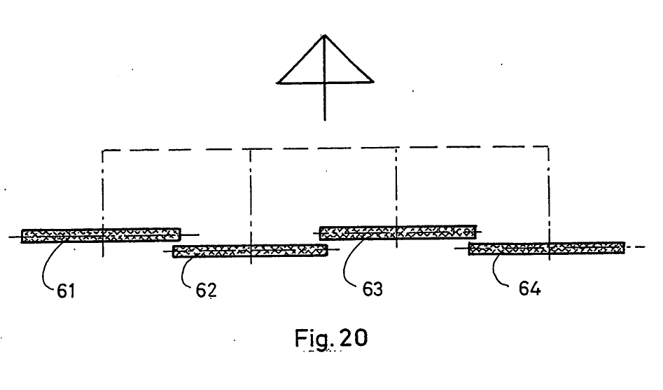

Yet other embodiments provide for greater numbers of liquid delivery apparatuses to be simultaneously towed behind a single vehicle. For example, the four drums 61, 62, 63 and 64 of four liquid delivery apparatuses are shown in deployed overlapping side-by-side formation in FIG. 20.

Various preferred embodiments of the present invention provide one or more of the following advantages:
a reduced risk of damage to the drum 7 and associated machinery due to inadvertent impacts with obstacles 17;
an improved potential for a higher travelling speed of the apparatus 1 over the ground surface 3 whilst retaining acceptable liquid delivery performance;
an improved control of liquid chemical saturation on the drum 7, potentially resulting in more efficient liquid chemical usage,
a reduced risk of liquid run-off when the drum 7 is on a sloping surface;
an increased chemical effectiveness due to incorporating a boomspray application of a liquid onto plant matter; and
a relatively easily implemented side-by-side operation of more than one liquid delivery apparatus 1.

Although the invention has been described with reference to specific examples, it will be appreciated by those skilled in the art that the invention may be embodied in many other forms.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A liquid delivery apparatus including:
a frame adapted for displacement relative to a ground surface having plant matter;
a drum rotatably disposed relative to said frame at a rest position having a height above said ground surface allowing for engagement of an outer circumferential surface of the drum with at least some of said plant matter; and
at least one applicator for application of a liquid onto said circumferential surface such that said liquid is transferable to said at least some of said plant matter as the frame is displaced relative to said ground surface; whereby
said drum is retractably mounted to said frame such that said drum retracts from said rest position upon engagement with a ground obstacle and returns to said rest position subsequent to engagement with said ground obstacle.

2. A liquid delivery apparatus according to claim 1, wherein the drum is retractably mounted to the frame by means of at least one swing arm.

3. A liquid delivery apparatus according to claim 2, wherein the swing arm is mounted to the frame for angular movement about a rotational axis which is transverse to a direction of displacement of the frame relative to the ground surface.

4. A liquid delivery apparatus according to claim 3, wherein the means for mounting the swing arm to the frame utilizes a torsional device and connecting lever.

5. A liquid delivery apparatus according to claim 3, wherein the means for mounting the swing arm to the frame utilizes a short connecting chain.

6. A liquid delivery apparatus according to claim 2, wherein the apparatus is provided with a detachable swing arm pivot point, in order to allow the swing arm pivot point and therefore the swing arm and attached drum, to be shifted if the operator desires to alter the location of the swing arm on the frame, so as to vary the degree of sensitivity in lifting the drum as described herein.

7. A liquid delivery apparatus according to claim 1, wherein the rest position is defined by engagement of the swing arm with a stop.

8. A liquid delivery apparatus according to claim 7, wherein the swing arm is biased toward the rest position.

9. A liquid delivery apparatus according to claim 7, wherein the biasing is controlled by means of gravitational biasing, resilient biasing or a combination of both.

10. A liquid delivery apparatus according to claim 2, wherein a proximate end of the swing arm is mounted to the frame and the drum is disposed at a distal end of the swing arm.

11. A liquid delivery apparatus according to claim 10, wherein the distal end trails the proximate end with reference to a direction of displacement of the frame relative to said ground surface.

12. A liquid delivery apparatus according to claim 11, wherein the applicator is disposed on the swing arm intermediate the proximate and distal ends.

13. A liquid delivery apparatus according to claim 2, wherein a movement sensor is included for detection of initial movement of the swing arm in response to engagement of the drum with an obstacle, or a proximity sensor is included for detection of an obstacle, so that once the movement or obstacle is sensed, an actuator, such as a hydraulic or electric actuator, is employed to force the drum upwardly and away from the obstacle.

14. A liquid delivery apparatus according to claim 1, wherein the apparatus includes spraying equipment, disposed on the frame so as to spray liquid onto plant matter.

15. A liquid delivery apparatus according to claim 14, wherein the spraying equipment is mounted on a boom, disposed on the frame.

16. A liquid delivery apparatus including:
a frame adapted for displacement relative to a ground surface having plant matter;
a drum rotatably disposed relative to said frame at a rest position defining a height above said ground surface allowing for engagement of an outer circumferential surface of the drum with at least some of said plant matter; and
at least one applicator for application of a liquid onto said circumferential surface such that said liquid is transferable to said at least some of said plant matter as the frame is displaced relative to said ground surface, said applicator providing a variable liquid application profile along a length of said outer circumferential surface.

17. A liquid delivery apparatus according to claim 16, whereby said drum is retractably mounted to said frame such that said drum retracts from said rest position upon engagement with a ground obstacle and returns to said rest position subsequent to engagement with said ground obstacle.

18. A liquid delivery apparatus according to claim 16, wherein the drum defines a first end and a second end opposite said first end and the length of the outer circumferential surface, along which the liquid application profile is variable, extends between the first and second ends.

19. A liquid delivery apparatus according to claim 18, wherein the variable liquid application profile is selectively adjustable so as to bias liquid application in favor of either the first end or the second end.

20. A liquid delivery apparatus according to claim 19, wherein the variable liquid application profile varies substantially linearly between a minimum at one of the first or second ends and a maximum at the other of the first or second ends.

21. A liquid delivery apparatus according to claim 20, wherein the applicator includes at least a first liquid delivery circuit being biased toward delivery of liquid in favor of the first end and a second liquid delivery circuit being biased toward delivery of liquid in favor of the second end, the applicator further including a first valve for regulation of a flow of liquid to the first liquid delivery circuit and a second valve for regulation of a flow of liquid to the second liquid delivery circuit.

22. A liquid delivery apparatus according to claim 21, wherein the first valve and the second valve are independently adjustable by a user.

23. A liquid delivery apparatus according to claim 22, wherein the applicator includes a tilt sensor for sensing of a tilt of said first end relative to said second end.

24. A liquid delivery apparatus according to claim 23, wherein a balance of liquid flows to the first liquid delivery circuit and/or the second liquid delivery circuit is regulated by the tilt sensor so as to maintain a substantially constant degree of liquid saturation across said circumferential surface.

25. A liquid delivery apparatus according to claim 24, wherein the tilt sensor and a liquid flow control valve are incorporated in one unit.

26. A liquid delivery apparatus including:
a frame adapted for displacement relative to a ground surface having plant matter;
a drum rotatably disposed relative to said frame at a rest position defining a height above said ground surface allowing for engagement of an outer circumferential surface of the drum with at least some of said plant matter, wherein said drum is retractably mounted to said frame such that said drum retracts from said rest position upon engagement with a ground obstacle and returns to said rest position subsequent to engagement with said ground obstacle;
at least one applicator for application of a liquid onto said circumferential surface such that said liquid is transferable to said at least some of said plant matter as the frame is displaced relative to said ground surface;
a saturation sensor for determining the degree of saturation of liquid on said circumferential surface, wherein the saturation sensor provides a measurement of the weight of the drum; a flow of liquid to said applicator being regulated by said sensor.

27. A liquid delivery apparatus according to claim 26, wherein the drum defines a first end and a second end opposite the first end and the saturation sensor includes a first weight sensing unit disposed adjacent the first end and a second weight sensing unit disposed adjacent the second end.

28. A liquid delivery apparatus according to claim 27, wherein a balance of liquid flows to the first liquid delivery circuit and/or the second liquid delivery circuit is regulated by the saturation sensor so as to maintain a substantially constant degree of liquid saturation across said circumferential surface.

29. A liquid delivery apparatus according to claim 1, wherein the frame is adapted for attachment at a hitching point of a vehicle, including a tractor, a four wheeled bike, a four wheel drive.

30. A liquid delivery apparatus according to claim 29, wherein the apparatus is adapted for mounting to the rear, front or the side of the vehicle.

31. A liquid delivery apparatus according to claim 29, wherein the operational height of the drum is adjusted by raising or lowering the hitching point.

32. A liquid delivery apparatus according to claim 1, wherein a fabric material, such as an absorbent material, provides the circumferential surface of the drum.

33. A liquid delivery apparatus according to claim 1, wherein the frame is supported by wheels.

34. A liquid delivery apparatus according to claim 1, wherein the frame is supported by a pair of skids.

35. A liquid delivery apparatus according to claim 34, wherein a smaller wheel is disposed at the base of the skid to allow the frame be displaced without dragging the skid, such as when towing the liquid delivery apparatus across paved surfaces, or over other surfaces when it is not being utilized.

36. A liquid delivery apparatus according to claim 1, wherein a locking mechanism is utilized to restrain the drum in the retracted or another locked position for the purpose of transporting the apparatus.

37. A liquid delivery apparatus according to claim 1, wherein the liquid chemical is stored in a reservoir and is pumped to an applicator which applies the liquid along the length of the circumferential surface of the drum.

38. A liquid delivery apparatus according to claim 37, wherein the apparatus includes drive means for rotating the drum.

39. A liquid delivery apparatus according to claim 38, wherein the drum is rotated by the drive means only whilst the drum is in the rest position, but when the drum is retracted from the rest position, it is allowed to freewheel, in order to assist the drum to ride over obstacles and also to avoid tearing of the fabric on the circumferential surface of the drum.

40. A liquid delivery apparatus according to claim 39, wherein the drive means is in the form of an electric or hydraulic motor, which rotationally engages the circumferential surface of the drum whilst it is in the rest position, the drive means being disengaged when the drum is retracted from the rest position, thereby allowing the drum to freewheel.

41. A liquid delivery apparatus according to claim 39, wherein the drive means is provided by a mechanical connection to a ground engaging wheel where available.

42. A liquid delivery system wherein first and second liquid delivery apparatuses are adapted for side-by-side deployment including:
a hitching point common to both said first and second liquid delivery apparatuses;
said first liquid delivery apparatus including:
a first frame having ground engagement means engaging the ground at a distance L₂ from said common hitching point; and
a first drum rotatably disposed relative to said first frame at a rest position defining a distance L₁ from said common hitching point;
said second liquid delivery apparatus including:
a second frame having ground engagement means engaging the ground at a distance L₄ from said common hitching point; and
a second drum rotatably disposed relative to said second frame at a rest position defining a distance L₃ from said common hitching point;
wherein a first ratio L₁:L₂ is substantially equal to a second ratio L₃:L₄ such that an adjustment to the height of the common hitching point results in an alteration to the height of said first drum which is substantially equal to an alteration to the height of said second drum.

43. A liquid delivery system according to claim 42, whereby each said drum is retractably mounted to each said respective frame such that said drum retracts from said rest position upon engagement with a ground obstacle and returns to said rest position subsequent to engagement with said ground obstacle.

44. A liquid delivery apparatus according to claim 43, wherein a liquid distribution coverage area provided by the first drum preferably overlaps with a liquid distribution coverage area provided by the second drum.
